(19) United States
(12) Patent Application Publication
(10) Pub. No.: US 2020/0196773 A1
(43) Pub. Date: Jun. 25, 2020

(54) INFANT CRY MUFFLER COVER

(71) Applicant: DENSO CORPORATION, Kariya-city, Aichi-pref. (JP)

(72) Inventors: Takuya OSUGI, Kariya-city (JP); Shun TOMIOKA, Kariya-city (JP); Akira INOUE, Kariya-city (JP)

(21) Appl. No.: 16/341,168

(22) PCT Filed: Feb. 1, 2017
(86) PCT No.: PCT/JP2017/003499

§ 371 Date: Apr. 11, 2019

(30) Foreign Application Priority Data
Dec. 21, 2016 (JP) 2016-248148

(51) Int. Cl. A47D 15/00; A41D 11/00; H04R 1/02; G10K 11/178; G10K 11/162; G06F 3/16

(52) U.S. Cl. CPC A47D 15/00; A41D 11/00; H04R 1/028; G10K 2210/3044; G10K 11/162; G06F 3/165; G10K 11/17873

(57) ABSTRACT

An infant cry muffler cover includes: a cover body including a sound insulation member for insulating a cry of an infant, the cover body having a sheet shape to cover the infant held on a front side of a body of a guardian; an opening portion defined at a central portion of an upper side of the cover body to be opened toward the infant at a neck of the guardian, the opening portion being curved in a direction away from the guardian; a neck string that connects both ends of the opening portion to each other to be put around the neck of the guardian; and a back string that connects both ends of the upper side of the cover body to each other to be put around a back of the guardian.

### CROSS REFERENCE TO RELATED APPLICATION

This application is based on Japanese Patent Application No. 2016-248148 filed on Dec. 21, 2016, the disclosure of which is incorporated herein by reference.

### TECHNICAL FIELD

The present disclosure relates to an infant cry muffler cover that restricts a cry of an infant from reaching the circumference.

### BACKGROUND ART

Conventionally, a cry conversion capsule disclosed in, for example, Patent Literature 1 has been known, for blocking a cry of an infant.

The cry conversion capsule is designed so that an infant is placed inside the capsule, and a lid is closed after the infant lies. A wall around the capsule is double-walled, making it difficult for the infant's cry to reach the outside (soundproof structure). Further, the capsule is provided with a condenser microphone and a tape recorder, and upon detection of the infant's cry by the condenser microphone, the tape recorder is activated to reproduce a laugher of the infant recorded in advance toward the outside of the capsule.

### PRIOR ART LITERATURES

### Patent Literature

Patent Literature 1: JP 2001-331180 A

### SUMMARY OF INVENTION

However, it is difficult to carry the capsule disclosed in Patent Literature 1 when going out, and it is difficult to cope with a case where the infant suddenly starts to cry in a public facility such as an airplane or a train. In addition, confining the infant in the capsule gives surrounding persons an impression such that the infant is coldly treated, thereby making use of the capsule difficult.

Furthermore, placing an infant in the capsule may reduce physical contact between the infant and the mother (communication in a broad sense) and adversely affect the development of the infant.

It is an object of the present disclosure to provide an infant cry muffler cover, which is excellent in convenience at the time of going out, and which is capable of preventing an infant's cry from leaking to surroundings while enabling a communication with the infant.

According to an aspect of the present disclosure, an infant cry muffler cover that restrains a cry of an infant from leaking to surroundings, the infant cry muffler cover includes:

a cover body including a sound insulation member for insulating the cry of the infant, the cover body having a sheet shape to cover the infant held on a front side of a body of a guardian;

an opening portion defined at a central portion of an upper side of the cover body to be opened toward the infant from a neck of the guardian, the opening portion being curved in a direction away from the guardian;

a neck string that connects both ends of the opening portion to each other to be put around the neck of the guardian; and

a back string that connects both ends of the upper side of the cover body to each other to be put around a back of the guardian.

According to the above configuration, the infant held on a front side of the guardian can be covered with the cover body. The cover body can be secured to the guardian by the neck string and the back string without slipping or tumbling from the guardian. Since the cover body is made of the sound insulation member, the leakage of the infant's cry to the surroundings can be reduced.

In addition, since the cover body is provided with the opening portion that opens to the infant side at a neck of the guardian, the guardian can easily speak to the infant while watching a facial expression of the infant or listening to the voice, that is, the guardian can easily communicate with the infant in a broad sense.

Further, since the cover body is formed in a sheet shape, the cover body can be folded and easily carried, and can be easily used when the infant cries out even at the outside, a public place (for example, inside a train, inside an airplane, or the like).

### BRIEF DESCRIPTION OF DRAWINGS

FIG. 1 is a front view illustrating an infant cry muffler cover according to a first embodiment.

FIG. 2 is an exploded perspective view illustrating a sound insulation member.

FIG. 3 is an explanatory view illustrating the infant cry muffler cover attached to a guardian.

FIG. 4 is a graph representing the muffler effect by the infant cry muffler cover.

FIG. 5 is an explanatory view illustrating an infant cry muffler cover according to a third embodiment.

FIG. 6 is an explanatory view illustrating an infant cry muffler cover according to a fourth embodiment.

FIG. 7 is an explanatory view illustrating an infant cry muffler cover according to a fifth embodiment.

FIG. 8 is an explanatory view illustrating an infant cry muffler cover according to a sixth embodiment.

FIG. 9 is an explanatory view illustrating an infant cry muffler cover according to a seventh embodiment.

FIG. 10 is an explanatory view illustrating an infant cry muffler cover according to an eighth embodiment.

FIG. 11 is an explanatory view illustrating an infant cry muffler cover according to a ninth embodiment.

FIG. 12 is an explanatory view illustrating an infant cry muffler cover according to an eleventh embodiment.

FIG. 13 is an explanatory view illustrating an infant cry muffler cover according to a twelfth embodiment.

### DESCRIPTION OF EMBODIMENTS

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

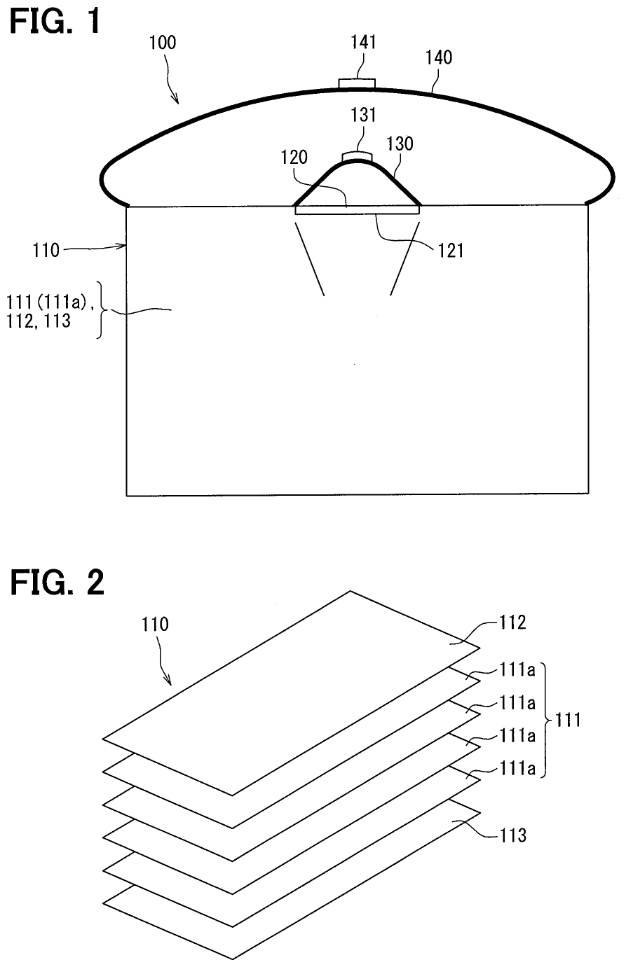

An infant cry muffler cover 100 according to a first embodiment will be described with reference to FIGS. 1 to 4. The infant cry muffler cover 100 (hereinafter referred to as silencing cover) restrains a cry of an infant from leaking to the surroundings, and includes a cover body 110, an opening portion 120, a neck string 130, a back string 140, and the like, as shown in FIGS. 1 and 2.

The cover body 110 is a sheet-like member having, for example, a rectangular shape to cover the infant held on a front side of the body of a guardian (for example, the mother), and has a sound insulation member 111, a front fabric 112, a back fabric 113, and the like. The cover body 110 is formed by stacking the sound insulation member 111, the front fabric 112, the back fabric 113, and the like on one another.

The sound insulation member 111 forms a sound insulation portion for insulating the cry of the infant, and is made of, for example, rectangular cloth materials 111a. The cloth material 111a is made of, for example, a curtain lace fabric, a polyester fabric, or the like. A size of the cloth material 111a is set according to a physical size of the guardian, and is set to, for example, about 70 cm in length and 100 cm in width. In the present embodiment, the sound insulation member 111 is formed by laminating (bonding) a plurality of cloth materials 111a (four sheets in this case) on one another. The number of laminates of the cloth material 111a is preferably about 2 to 4.

The surface of each cloth material 111a is coated with a sound insulation coating. As the sound insulation coating, for example, coating with titanium oxide is employed. Minute irregularities are formed (three-dimensionally formed) on a surface of the cloth material 111a by coating with titanium oxide, and an air layer is formed between the cloth materials 111a stacked on one another by the unevenness. The air layer effectively shields the cry of the infant (for example, the cry in a frequency range around 3000 Hz). A waterproofing layer subjected to a waterproofing treatment may be formed on the surface of the sound insulation member 111.

The front fabric 112 is, for example, a cloth material on which a fashionable pattern or a pattern having warmth (flower pattern, geometric pattern, or the like) is provided. The front fabric 112 has a size substantially equal to that of the sound insulation member 111, and is detachably attached on the front side of the sound insulation member 111. Around each of the sound insulation member 111 and the front fabric 112, there are provided a hook and loop fastener (registered trademark: magic tape), buttons, and the like for joining the sound insulation member 111 and the front fabric 112 to each other, and the front fabric 112 is detachably attached to the sound insulation member 111 by those hook and loop fastener, buttons, and the like.

The back fabric 113 is a cloth material having a size substantially equal to that of the sound insulation member 111, and is detachably attached on the back side of the sound insulation member 111. The back fabric 113 is made of, for example, an organic cotton material having good breathability and good texture. Similar to the case of the front fabric 112, a hook and loop fastener (registered trademark: magic tape), buttons, or the like for joining the sound insulation member 111 and the back fabric 113 to each other is provided around each of the sound insulation member 111 and the back fabric 113. The back fabric 113 is detachably attached to the sound insulation member 111 by the hook and loop fastener, the buttons, or the like.

When used in summer, the back fabric 113 may be made of, for example, a silk fabric, a dry shirt fabric, or a mesh fabric having permeability, in place of the organic cotton fabric described above. In the case of use in winter, a fleece fabric or a towel fabric having heat insulation may be used.

The opening portion 120 is formed by a central portion of the upper side of the cover body 110 shaped in a quadrangle, and is curved in an-inverted-U-shape in a direction away from the guardian side to be opened to the infant side at the neck of the guardian.

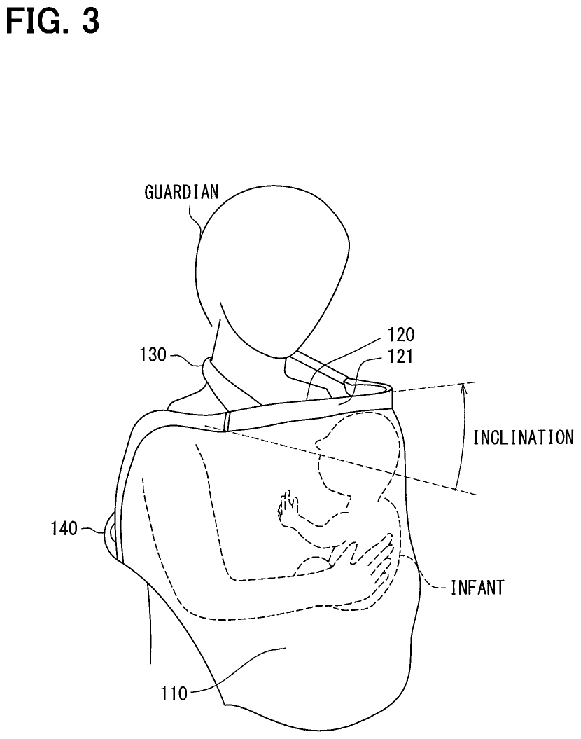

As shown in FIG. 3, a periphery of the opening portion 120 is inclined upward to the cover body so that a center portion curved between both end portions of the inverted-U-shape is positioned on an upper side of the both end portions. An angle of inclination is, for example, about 30 degrees.

A shape holding portion 121 is provided around the opening portion 120, that is, in a region corresponding to the opening portion 120 on the upper side of the square of the cover body 110. The shape holding portion 121 holds the opening portion 120 in the inverted-U-shape curved state. The shape holding portion 121 is made of, for example, a shape memory metal (wire-like member), a shape memory resin, or the like. The shape holding portion 121 can be deformed in accordance with a folding line when the cover body 110 is folded, and returns to the inverted-U-shape curved state described above when the cover body 110 is unfolded.

The neck string 130 is a string member provided on the cover body 110. The neck string 130 is formed to connect both ends of the inverted-U-shape of the opening portion 120, and serves as a portion to be hung on a neck of the guardian.

The neck string 130 is made of, for example, a cloth material, and has a length adjustment portion 131 that allows a length adjustment of the neck string 130 at an intermediate portion.

The neck string 130 may be made of an elastic member such as a rubber member, instead of the one formed of the cloth material and having the length adjustment portion 131. In this case, the length adjustment portion 131 may be unnecessary.

The back string 140 is a string member provided on the cover body 110. The back string 140 is formed to connect both ends of the upper side of the cover body 110 to each other, and serves as a portion to be hung on a back of the guardian.

The back string 140 is made of, for example, a cloth material, and has a length adjustment portion 141 at an intermediate portion of the back string 140, which enables a length adjustment of the back string 140.

The back string 140 may be made of an elastic member (rubber string) such as a rubber member, instead of the cloth material having the length adjustment portion 141. In this case, the length adjustment portion 141 may be unnecessary.

The silencing cover 100 formed as described above is used as follows (as shown in FIG. 3).

The guardian holds the infant on the front side of the body, and the head and the upper body of the guardian are made to pass through the back string 140, thereby putting the back string 140 on the back of the guardian. Similarly, the guardian puts his/her head through the neck string 130 to put the neck string 130 on the neck of the guardian. With the above action, the silencing cover 100, (the cover body 110) is worn by the guardian so as to completely cover the infant. At that time, the opening portion 120 faces the guardian side and opens to the infant side at the guardian's neck.

According to the present embodiment, the infant held on the front side of the body of the guardian can be covered by the cover body 110. The cover body 110 can be secured to the guardian by the neck string 130 and the back string 140 without slipping or rubbing from the guardian. Since the cover body 110 has the sound insulation member 111, the cry of the infant can be restrained from leaking to the surroundings.

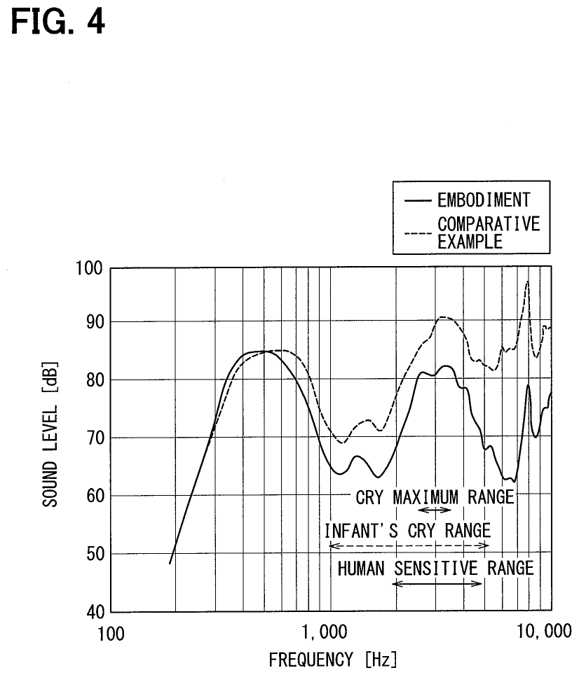

FIG. 4 shows the effects of silencing the cry of the infant by the present silencing cover 100. The cry data (volume data with respect to frequency) is measured by a microphone set at a predetermined distance (for example, 1 m) from the infant. A dotted line in FIG. 4 shows experimental results in a comparative example in which the silencing cover 100 is not used. A solid line in FIG. 4 shows the experimental result in the present embodiment with the use of the present silencing cover 100, and a difference between the solid line and the dotted line indicates the silent effect of the present silencing cover 100 on the cry of the infant.

In general, it is assumed that a person becomes sensitive to sound within sound range of approximately 2000 Hz to 5000 Hz. A sound range of the cry of the infant is 1000 Hz to 5000 Hz, and a sound range in which the cry is maximized is 2500 Hz to 3500 Hz. With the use of the silencing cover 100, the sound volume reduction effect is obtained over the entire region of 500 Hz or more. In particular, a sound volume reduction of about 5 to 15 dB is obtained in the cry sound region of the infant and the sound volume reduction of about 10 dB is obtained in the maximum cry sound region. Thus, a sufficient silencing effect is observed.

In addition, since the cover body 110 is formed with the opening portion 120 that opens to the infant side at the neck of the guardian, the guardian can easily speak to or amuse the infant while watching the facial expression of the infant or listening to the voice of the infant, that is, that guardian can easily communicate with the infant in a broad sense.

Further, since the cover body 110 is formed in a sheet, the cover body 110 can be folded and easily carried, and can be easily used at the outside, a public place (for example, in a train, in an airplane, or the like) when an infant begins to cry.

The cover body 110 is formed by stacking the sound insulation members 111 on one another. As a result, the effect of insulating the infant's cry can be enhanced.

The sound insulation member 111 includes the cloth materials 111a whose surface is coated with a sound insulation coating (a coating of titanium oxide). As a result, a sound insulation member having excellent sound insulation properties can be obtained with the use of a familiar material.

In addition, minute irregularities are formed on the surface of the cloth material 111a by the sound insulation coating, and an air layer is formed between the multiple stacked sound insulation members. The air layer can enhance the sound insulation effect.

A waterproofing layer subjected to a waterproofing treatment is formed on the surface of the sound insulation member 111. This makes it possible to prevent the sound insulation coating from becoming sticky by washing, and to improve the durability.

In addition, the cover body 110 has the front fabric 112 provided on the front side of the sound insulation member 111 so as to be detachably attached onto the sound insulation member 111. As a result, for example, the front fabric 112 may be provided with a fashionable pattern, a warm pattern, or the like, which may be mounted or replaced as desired, and used with a stylish sensation.

Further, the cover body 110 has the back fabric 113 which is detachably attached onto the sound insulation member 111 and has an air permeability or a heat insulation property on the back side of the sound insulation member 111. As a result, in the case where the back fabric 113 having the air permeability is attached to the sound insulation member 111, the presence of moisture in the cover body 110 can be reduced in summer, thereby being capable of improving the comfort of the infant. Further, in the case where the back fabric 113 having the heat insulation property is attached to the sound insulation member 111, the infant can be protected from low temperature in winter.

The periphery of the opening portion 120 is inclined to the cover body, and is formed so that the curved center portion is positioned on the upper side than the both ends of the opening portion 120. As a result, an area covering the infant can be increased without impairing the opening state by the opening portion 120, and the cry of the infant can be restrained from leaking (diffracting) to the surroundings, thereby being capable of enhancing the sound insulation effect.

The shape holding portion 121 that holds the opened shape is provided around the opening portion 120. As a result, the shape of the opening portion 120 can be stably held by the shape holding portion 121 in the cover body 110 formed in a sheet shape.

The neck string 130 has the length adjustment portion 131 that enables a length adjustment of the neck string. As a result, the neck string 130 can be set according to the physical size of the guardian, and the cover body 110 can be mounted in a state of being fitted to the guardian.

It should be noted that the neck string 130 may be made of a stretchable elastic member. In this case, the length adjustment portion 131 described above is unnecessary, and the cover body 110 can be mounted in a state of being fitted to the guardian.

Like the neck string 130, the back string 140 has the length adjustment portion 141 that enables a length adjustment of the back string. As a result, the back string 140 that conforms to the physical size of the guardian can be obtained, and the cover body 110 can be mounted in a state of being fitted to the guardian.

It should be noted that the neck string may be made of an stretchable elastic member. As a result, the cover body 110 can be mounted in a state of being fitted to the guardian without the length adjustment portion 141 for the back string.

### (Modification)

The silencing cover 100 may be configured as described below without being limited to the first embodiment.

The sound insulation member 111 is constructed by plural (for example, four) of cloth materials 111a stacked on one another, but not limited to four, and may have a configuration of two sheets, three sheets, or five sheets or more. In addition, the sound insulation member 111 may be made of one sheet in accordance with the sound insulation effect. In addition, the thickness may be changed in accordance with the number of sheets of the sound insulation member

The sound insulation member 111 is not limited to the one made of the cloth material 111a coated with a sound shielding material, and may be made of, for example, a foamed resin material such as polyurethane, a rubber material, or the like.

The waterproofing layer may be formed on the sound insulation member 111 as necessary, or may be omitted.

The front fabric 112 and the back fabric 113 are provided as the cover body 110 over the sound insulation member 111. Alternatively, either or both of the front fabric 112 and the back fabric 113 may be eliminated, while the silencing cover 100 includes at least the sound insulation member 111.

The periphery of the opening portion 120 is set to be inclined so that the curved center portion is positioned above the both end portions, but the present disclosure is not limited to the above configuration. For example, the both end portions and the curved center portion may be set to have the same height (along the same horizontal line).

The shape holding portion 121 may be set as necessary for the opening portion 120, and may be omitted.

The lengths of the neck string 130 and the back string 140 may be set in advance in consideration of the physical size of the guardian, so that the length adjustment portions 131 and 141 may be eliminated.

In the first embodiment and the modification, the plural sound insulation members 111 may be set so that the sound insulation characteristics are different from one another with respect to the frequency. For example, the first sheet is made of a material for most effectively insulating sounds with 2000 Hz, the second sheet is made of a material for most effectively insulating sounds with 3000 Hz, the third sheet is made of a material for most effectively insulating sounds with 4000 Hz, and the fourth sheet is made of a material for most effectively insulating sounds with 5000 Hz. As a result, the sound insulation range (sound frequency region) can be set wide.

### Second Embodiment

In contrast to the first embodiment and the modification, a water repellent layer that has been subjected to a water repellent treatment may be formed on a surface of the front fabric 112. Accordingly, even in the case where it suddenly rains out, the cover body 110 can be utilized as a rain tool covering the head, since the water repellent layer is formed on the front fabric 112.

A mounting portion that enables mounting of a blanket may be formed on the surface of the front fabric 112. As a result, since the blanket can be mounted on the surface of the front fabric 112 by the mounting portion, the infant can be warmly wrapped in winter.

The guardian may be provided with a letter or a graphic display on the front fabric 112 for indicating to surrounding persons that both hands are not usable since the infant is held by the both hands. The guardian uses both hands to hold the infant inside the cover body 110, but not visible from the outside. Accordingly, the surrounding persons can understand that neither hands can be used, due to the display on the front fabric 112 described above, even without saying to the surrounding persons.

In addition, a reflection portion for reflecting sunlight or a cut portion for cutting ultraviolet rays may be formed on the surface of the cover body 110. This makes it possible to reduce the temperature rise in the cover body 110 due to sunshine in summer by the reflection portion, for example, and makes it possible to take measures against the heat for the infant. In addition, the effect of the ultraviolet rays on the infant can be reduced by the cut portion.

### Third Embodiment

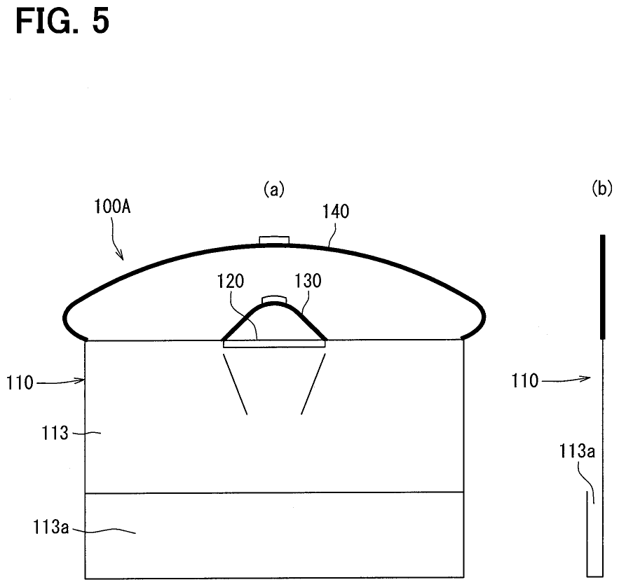

A silencing cover 100A according to a third embodiment is shown in FIG. 5. In a third embodiment, in contrast to the first embodiment and the modification described above, a back fabric 113 is provided with a foot pocket 113a that allows feet of an infant to be inserted. As a result, since a part of weight of the infant can be supported by inserting the feet of the infant into the foot pocket 113a, a burden of a guardian holding the infant can be reduced.

In addition, an antimicrobial layer subjected to an antimicrobial treatment may be formed on a surface of the back fabric 113. This makes it possible to reduce and kill antimicrobial and bacterial growth, and to keep the environment for the infant in the cover body 110 clean.

### Fourth Embodiment

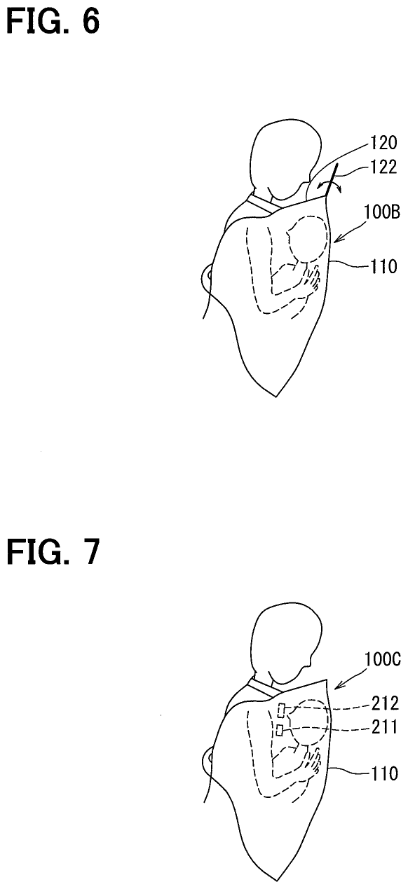

A silencing cover 1006 according to a fourth embodiment is shown in FIG. 6. In the fourth embodiment, an opening portion 120 is provided with a lid portion 122 that allows the opening portion 120 to be opened and closed, as compared with the first embodiment and the modification. The lid portion 122 may be made of a transparent member or a mesh member.

When the infant cries violently, the opening portion 120 is closed with the lid portion 122, thereby being capable of reducing leakage of cry from the opening portion 120, while it is impossible for the guardian to communicate with the infant through the opening portion 120.

Further, when the lid portion 122 is made of a transparent member, a mesh member, or the like, even when the opening portion 120 is closed with the lid portion 122, the guardian can confirm the infant to some extent. Therefore, the communication is possible to some extent, compared with the case where the opening portion is completely closed with a blind lid.

### Fifth Embodiment

FIG. 7 shows a silencing cover 100C according to a fifth embodiment. In the fifth embodiment, a microphone 211 for capturing a cry of an infant and a generator 212 (active noise canceller) for generating an opposite-phase sound wave with a phase opposite from the phase of the sound wave of the cry captured by the microphone 211 are provided inside a cover body 110 as compared with the first embodiment and the modification.

As a result, the infant's cry can be canceled by the opposite-phase sound wave generated from the generator 212, so that the cry can be restricted from being heard by the surroundings.

### Sixth Embodiment

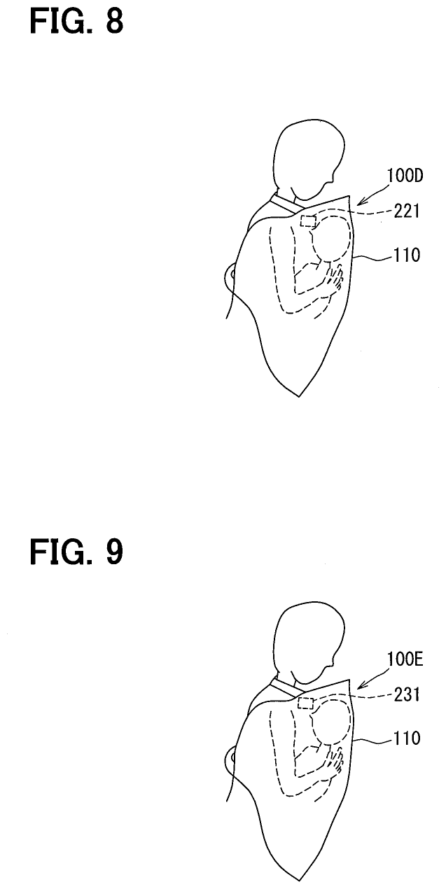

A silencing cover 100D according to a sixth embodiment is shown in FIG. 8. In the sixth embodiment, a speaker device 221 for playing a sound or a song to calm down an infant is provided inside a cover body 110, in contrast to the first embodiment and the modification. The sound may be moderate noise sounds, fetal movement sounds, streaming sounds in a river, forest sounds, and the like. The song for the infant can be a lullaby or the like.

As a result, the infant can be calmed down to stop the crying by the sound or music played from the speaker device 221.

### Seventh Embodiment

A silencing cover 100E according to a seventh embodiment is shown in FIG. 9. In the seventh embodiment, a fan 231 for blowing an air toward an infant is provided inside a cover body 110 in contrary to the first embodiment and the modification. The fan 231 is, for example, a battery-driven small fan.

As a result, since the fan 231 can blow the air toward the infant in summer, the environment of the infant in the cover body 110 can be made comfortable.

### Eighth Embodiment

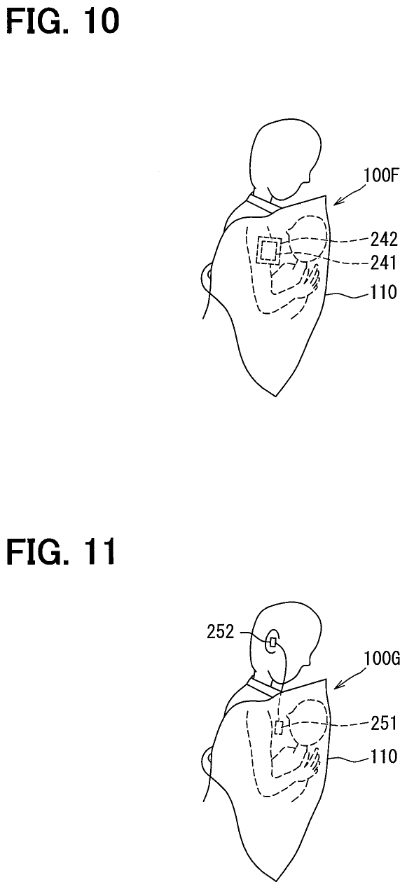

A silencing cover 100F according to an eighth embodiment is shown in FIG. 10. In the eighth embodiment, a holding portion 242 that holds a cold storage material 241 for providing a cool air in a cover body 110 may be provided inside the cover body 110, as compared with the first embodiment and the modification. The holding portion 242 may be, for example, a pocket provided in a predetermined portion of a back fabric 113 of the cover body 110.

This makes it possible to retain the cold storage material 241 in the holding portion 242, and the cold storage material 241 can discharge a cool air in the cover body 110 in summer, and can make the environment of the infant in the cover body 110 comfortable.

### Ninth Embodiment

A silencing cover 100G according to a ninth embodiment is shown in FIG. 11. In the ninth embodiment, as compared with the first embodiment and the modification, the cover body 110 is provided with a sound collecting microphone 251 for collecting a voice of an infant and an earphone 252 for outputting the voice of the infant collected by the sound collecting microphone 251 so as to be attachable to an ear of a guardian.

As a result, the voice of the infant is collected by the sound collecting microphone 251, and the guardian can reliably hear the voice of the infant collected by the earphone 252, and can more accurately know a current state of the infant.

### Tenth Embodiment

In contrast to the first embodiment and the modification, a cover body 110 may be provided with a holding portion that holds the cover body 110 in a folded state. The holding portion may be, for example, a storage pocket portion provided at a predetermined position of the cover body 110 and capable of storing the folded cover body 110 itself, a fixing belt portion fixed in a folded state, a string portion, or the like.

As a result, since the cover body 110 is held in the folded state by the holding portion, the cover body 110 is easily carried when being not used as the silencing cover 100.

### Eleventh Embodiment

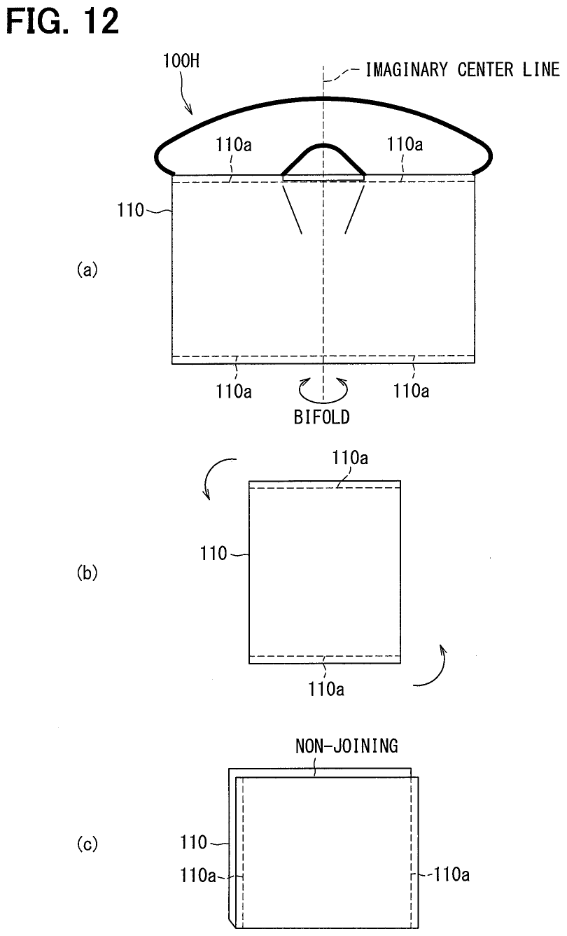

A silencing cover 100H according to an eleventh embodiment is shown in FIG. 12. In the eleventh embodiment, the cover body 110 is provided with a joint portion 110a which can join predetermined portions around the cover body 110 to one another and hold the cover body 110 in a bag shape while partially leaving a non-joint portion, as compared with the first embodiment and the modification.

The joint portion 110a may be, for example, a hook and loop fastener, a normal fastener, a button, or the like provided on upper and lower sides of the cover body 110. For example, as shown in (a) of FIG. 12, the cover body 110 is folded in two pieces along an imaginary center line extending in the vertical direction. As shown in (b) of FIG. 12, the overlapping portions are joined to each other by the joint portion 110a on the upper and lower sides, and rotated by 90 degrees, thereby making it possible to form a large bag in which the upper side becomes a non-joining portion (opening portion) as shown in (c) of FIG. 12.

As a result, the predetermined portions around the cover body 110 are joined to each other by the joint portion 110a, and the non-joining portion is left, whereby the cover body 110 can be held in a bag shape, and can be used as a bag for storing goods when not used as the silencing cover 100.

### Twelfth Embodiment

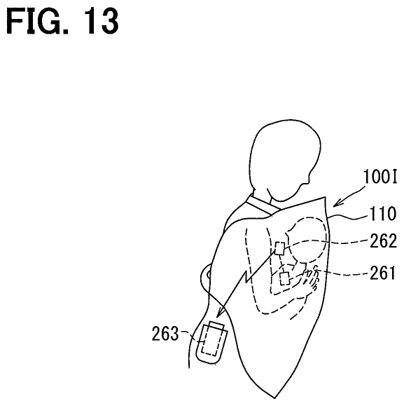

A silencing cover 1001 according to a twelfth embodiment is shown in FIG. 13. In the twelfth embodiment, in contrast to the first embodiment and the modification, the cover body 110 is provided with an acquisition unit 261 that acquires voice data of a cry of an infant and biometric data of the infant, and a transmission unit 262 that transmits the voice data and the biometric data acquired by the acquisition unit 261 to a mobile device 263 carried by a guardian.

Among the voice data and the biometric data acquired by the acquisition unit 261, the biometric data includes, for example, a body temperature, a pulse, a pulse wave, a motion, and the like.

As a result, the voice data and the biometric data of the infant can be acquired by the acquisition unit 261, and the data can be transmitted to the mobile device 263 by the transmission unit 262. Therefore, the infant's cry and the physical condition at that time can be associated with each other according to the transmitted data, and an emotional analysis of the infant can be performed.

1. An infant cry muffler cover that restrains a cry of an infant from leaking to surroundings, the infant cry muffler cover comprising:
a cover body including a sound insulation member to insulate the cry of the infant, the cover body having a sheet shape to cover the infant held on a front side of a body of a guardian;
an opening portion defined at a central portion of an upper side of the cover body to be opened toward the infant at a neck of the guardian, the opening portion being curved in a direction away from the guardian;
a neck string that connects both ends of the opening portion to each other to be put around the neck of the guardian; and
a back string that connects both ends of the upper side of the cover body to each other to be put around a back of the guardian.

2. The infant cry muffler cover according to claim 1, wherein the cover body is formed by stacking a plurality of sound insulation members on one another.

3. The infant cry muffler cover according to claim 2, wherein the sound insulation member is made of a cloth material having a sound insulation coating on a surface of the cloth material, a foamed resin material, or a rubber material.

4. The infant cry muffler cover according to claim 3, wherein the sound insulation member is made of the cloth material having the sound insulation coating on the surface of the cloth material, and
minute irregularities are formed on the surface of the cloth material by the sound insulation coating, and an air layer is formed between the plurality of sound insulation members.

5. The infant cry muffler cover according to claim 4, wherein a waterproofing layer subjected to a waterproofing treatment is formed on the surface of the sound insulation member.

6. The infant cry muffler cover according to claim 2, wherein the plurality of sound insulation members are respectively set to have different sound insulation characteristics with respect to a frequency.

7. The infant cry muffler cover according to claim 1, wherein the cover body has a front fabric on a front side of the sound insulation member, and the front fabric is detachably attached to the sound insulation member.

8. The infant cry muffler cover according to claim 7, wherein a water repellent layer subjected to a water repellent treatment is formed on a surface of the front fabric.

9. The infant cry muffler cover according to claim 7, wherein a mounting portion enabling mounting of a blanket is formed on the surface of the front fabric.

10. The infant cry muffler cover according to claim 7, wherein the front fabric is provided with a letter or a graphic indication to indicate to a surrounding person that the guardian is not able to use both hands as the guardian holds the infant.

11. The infant cry muffler cover according to claim 1, wherein a reflection portion for reflecting sunlight or a cut portion for cutting ultraviolet rays is formed on a surface of the cover body.

12. The infant cry muffler cover according to claim 1, wherein the cover body has a back fabric that is detachably attached to the sound insulation member on a back side of the sound insulation member and has an air permeability or a heat insulation property.

13. The infant cry muffler cover according to claim 12, wherein the back fabric is provided with a foot pocket into which an infant's foot is inserted.

14. The infant cry muffler cover according to claim 12, wherein an antimicrobial layer subjected to an antimicrobial treatment is formed on a surface of the back fabric.

15. The infant cry muffler cover according to claim 1, wherein a periphery of the opening portion is inclined to the main cover, and the curved central portion is positioned on an upper side of the both ends of the opening portion.

16. The infant cry muffler cover according to claim 1, further comprising: a shape holding portion that holds an opened shape of the opening portion around the opening portion.

17. The infant cry muffler cover according to claim 1, wherein the opening portion is provided with a lid portion that allows the opening portion to be opened and closed.

18. The infant cry muffler cover according to claim 17, wherein the lid portion is made of a transparent member or a mesh member.

19. The infant cry muffler cover according to claim 1, wherein the neck string has a length adjustment portion which enables a length adjustment of the neck string.

20. The infant cry muffler cover according to claim 1, wherein the neck string is made of a stretchable elastic member.

21. The infant cry muffler cover according to claim 1, wherein the back string has a length adjustment portion that allows a length adjustment of the back string.

22. The infant cry muffler cover according to claim 1, wherein the neck string is made of a stretchable elastic member.

23. The infant cry muffler cover according to claim 1, wherein the cover body includes
a microphone that captures the cry of the infant; and
a generator that generates an opposite phase sound wave having an opposite phase to the sound wave of the cry captured by the microphone.

24. The infant cry muffler cover according to claim 1, wherein the cover body includes a speaker device that plays a sound or a song soothing the infant.

25. The infant cry muffler cover according to claim 1, wherein the cover body has a fan that blows an air toward the infant.

26. The infant cry muffler cover according to claim 1, wherein the cover body has a holding portion that holds a cold storage material to supply a cold air in the cover body.

27. The infant cry muffler cover according to claim 1, wherein the cover body includes
a sound collection microphone that collects a voice of the infant, and
an earphone that is attachable to an ear of the guardian and outputs the voice of the infant collected by the sound collection microphone.

28. The infant cry muffler cover according to claim 1, wherein the cover body includes a holding portion that holds the cover body in a folded state.

29. The infant cry muffler cover according to claim 1, wherein the cover body includes a joint portion that allows predetermined peripheral portions of the cover body to be joined to one another to hold the cover body in a bag shape while partially leaving a non-joining portion of the cover body.

30. The infant cry muffler cover according to claim 1, wherein the cover body includes
an acquisition unit that acquires voice data of the cry of the infant and biometric data of the infant, and
a transmission unit that transmits the voice data and the biometric data acquired by the acquisition unit to a mobile device carried by the guardian.
